(19) United States
(12) Patent Application Publication
(10) Pub. No.: US 2011/0234910 A1
(43) Pub. Date: Sep. 29, 2011

(54) Resolution changing device, resolution changing method, and resolution changing program

(75) Inventor: Akinori Takayama, Kawasaki (JP)

(73) Assignee: FUJITSU LIMITED, Kawasaki (JP)

(21) Appl. No.: 13/067,529

(22) Filed: Jun. 7, 2011

Related U.S. Application Data
(63) Continuation of application No. PCT/JP2008/073715, filed on Dec. 26, 2008.

(51) Int. Cl. H04N 9/74

(52) U.S. Cl. 348/581; 348/E09.055

(57) ABSTRACT

A resolution changing device acquires resolution information on a display device, enlarges a received video image by using a predetermined enlargement rate, and displays, on a screen, an area of the enlarged video image that meets a predetermined display resolution. The resolution information identifies an effective resolution that is a video resolution that indicates the area of the video image before the enlargement, which is the area that will be displayed on the screen. The acquiring unit then changes the resolution of the whole computer display to be displayed on the screen to an effective resolution that is identified according to the acquired resolution information.

### CROSS-REFERENCE TO RELATED APPLICATION

This application is a continuation of International Application No. PCT/JP2008/073715, filed on Dec. 26, 2008, the entire contents of which are incorporated herein by reference.

### FIELD

The embodiments discussed herein are directed to a resolution changing device, a resolution changing method, and a resolution changing program.

### BACKGROUND

Upon receiving a video image from a broadcast station, a television (hereinafter, “TV”) increases the video image resolution (number of horizontal pixels×number of vertical pixels) of the received video image by a predetermined increase rate and displays, on its screen, an area of the resolution-increased video image, which is an area meeting a predetermined display resolution. This aims at not displaying distortion and noise that are contained along the edge of the video image.

For example, as illustrated in FIG. 11, the TV enlarges (overscans) the received video image (see (1)) and displays only the center portion of the overscanned received video image (see (2)) that meets the display resolution of the screen (solid frame). The TV does not display the portions (upper, bottom, left, and right portions) that do not meet the display resolution and thus distortion and noise that is contained along the edge of the video image are not displayed. In other words, only the area of the video image before overscan that meets a predetermined resolution (hereinafter, “effective display viewing angle”) is displayed on the screen (see (1)). FIG. 11 is a diagram illustrating such conventional technology.

In recent years, TVs have been used for not only displaying video images that are received from broadcast stations but also displaying, on the screen, video images that are received from computers (hereinafter, “computer display”). In this case, as well, a TV enlarges the computer display and displays only the center portion of the enlarged display that meets the display resolution, but there may be important information, such as icons necessary for the user to operate the computer, along the edge of the computer display.

For this reason, the user manually adjusts the resolution of the computer display while checking the computer display on the TV such that the whole computer display is displayed on the whole screen of the TV (hereinafter, “full screen display”). Technologies are also disclosed that pre-reduce the resolution of the computer display by using a rate of reduction obtained in consideration of the maximum increase rate (overscan rate) among overscan rates that are different between TVs.
Patent Document 1: Japanese Laid-open Patent Publication No. 07-129138
Patent Document 2: Japanese Laid-open Patent Publication No. 2006-107009

The conventional technologies have a problem in that when the TV displays a computer display, full screen display may not be possible. More specifically, in the conventional technologies that previously reduce the resolution by using a reduction rate obtained in consideration of the maximum overscan rate, because the resolution is reduced by a uniform reduction rate even though the overscan rate differs between TVs, the full screen display may not be possible.

### SUMMARY

According to an aspect of an embodiment of the invention, a resolution changing device includes an acquiring unit that acquires resolution information on a display device that enlarges a received video image by using a predetermined enlargement rate and displays, on a screen, an area of the enlarged video image, which is an area meeting a predetermined display resolution, the resolution information identifying an effective resolution that is a video image resolution that indicates the area of the video image before the enlargement, which is an area to be displayed on the screen; and a changing unit that changes a resolution of the whole of a computer display to be displayed on the screen to the effective resolution that is identified according to the resolution information acquired by the acquiring unit.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram of an overview of a resolution changing device of a first embodiment of the present invention;

FIG. 2 is a block diagram illustrating a configuration of the resolution changing device of the first embodiment;

FIG. 3 is a diagram illustrating a TV of the first embodiment;

FIG. 4 is a table of a display area information storage unit of the first embodiment;

FIG. 5 is a flowchart of a process performed by the resolution changing device of the first embodiment;

FIG. 6 is a diagram illustrating effects of the resolution changing device of the first embodiment;

FIG. 7 is a block diagram illustrating a configuration of the resolution changing device of a second embodiment of the present invention;

FIG. 8 is a table for describing a TV storage unit of a second embodiment of the present invention;

FIG. 9 is a flowchart of a process performed by a resolution changing device of a third embodiment of the present invention;

FIG. 10 is a diagram illustrating a program of the resolution changing device of the first embodiment; and

FIG. 11 is a diagram illustrating conventional technology.

### DESCRIPTION OF EMBODIMENTS

Preferred embodiments of the present invention will be explained with reference to accompanying drawings. An overview, a configuration, and the flow of a process performed by a resolution changing device of an embodiment will be described below in the order they appear in this sentence and then other embodiments will be described.

### [a] First Embodiment

Overview of Resolution Changing Device

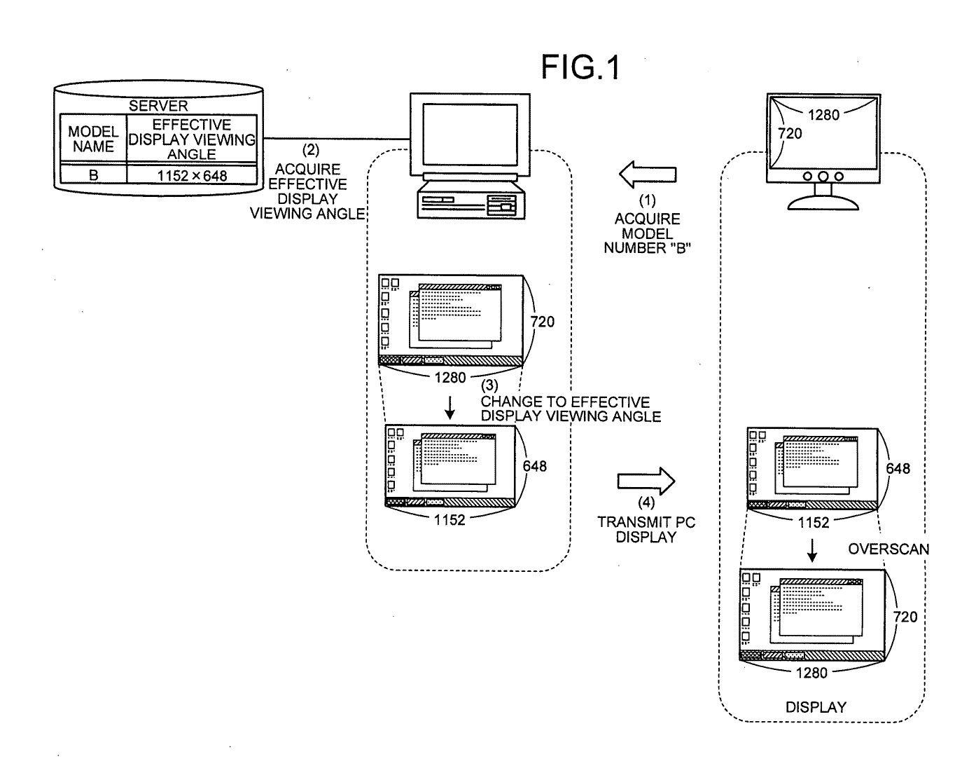

First, an overview of a resolution changing device of a first embodiment of the present invention will be described using FIG. 1. FIG. 1 is a diagram illustrating an overview of the resolution changing device of the first embodiment.

The resolution changing device of the first embodiment transmits a video image to a TV and then the TV displays the video image that is received from a computer (hereinafter, “computer display”) on the screen of the TV. The TV enlarges (overscans) the received computer display by using a predetermined increase rate and then displays, on its screen, an area of the enlarged computer display, which is an area meeting a predetermined display resolution. Hereinafter, descriptions will be provided on the premise that the display resolution of the TV is “1280×720” unless otherwise stated.

The resolution changing device of the first embodiment acquires display area information (resolution information) that identifies an effective display viewing angle (effective resolution) that is a resolution indicating an area of the computer display before enlargement, which is an area that will be displayed on the TV screen.

For example, in the example in FIG. 1, the resolution changing device of the first embodiment is connected to a server that stores the effective display viewing angle in association with the model name of the TV and, as illustrated in (1) of FIG. 1, acquires the TV's model name “B”. As illustrated in (2) of FIG. 1, the resolution changing device acquires, from the server, the effective display viewing angle “1152×648” corresponding to the acquired model name.

As illustrated in (3) of FIG. 1, the resolution changing device of the first embodiment changes the resolution of the whole computer display to be displayed on the screen to the effective display viewing angle that is identified according to the acquired display area information. For example, the resolution changing device changes the resolution of the whole computer display to “1152×648”.

As illustrated in (4) of FIG. 1, the resolution changing device of the first embodiment transmits the computer display to the TV and the TV overscans the computer display and then displays the overscanned computer display.

In the above-described manner, the resolution changing device of the first embodiment can display the whole computer display on the whole screen of the TV (hereinafter, “full screen display”). For example, in the example illustrated in FIG. 1, the resolution changing device previously changes the resolution of the whole computer display to “1152×648” and then transmits the computer display to the TV. Because the TV increases the resolution of the computer display from “1152×648” to “1280×720”, the whole computer display can be accordingly displayed using the whole display resolution “1280×720” of the TV.

Configuration of Resolution Changing Device

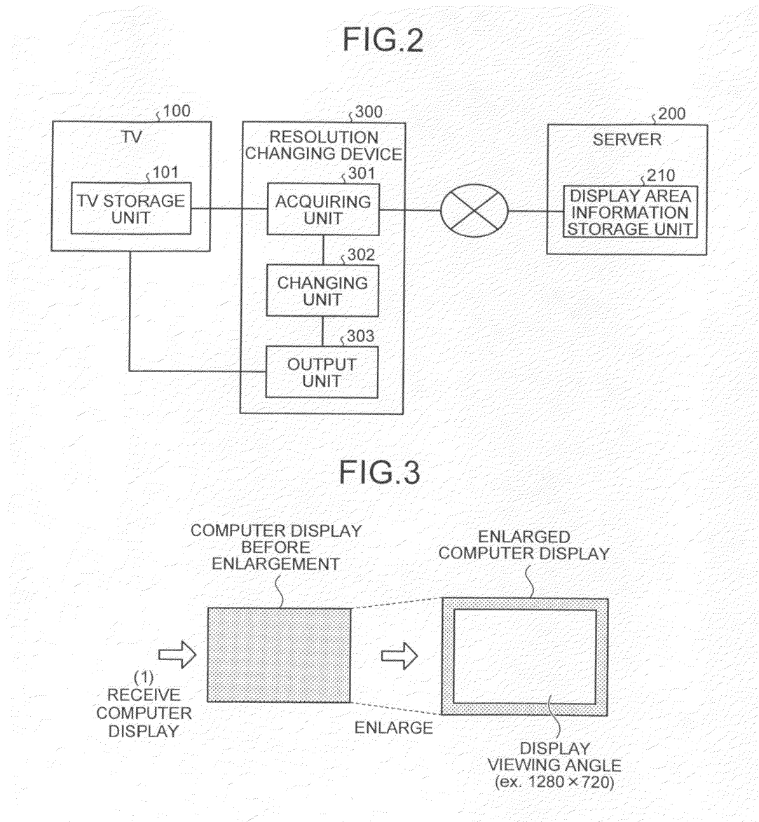

Next, a configuration of a resolution changing device 300 in FIG. 1 will be described using FIG. 2. FIG. 2 is a block diagram illustrating a configuration of the resolution changing device of the first embodiment. The resolution changing device 300 includes an internal memory for storing programs that define procedures of various types of changing processes and executes the various types of changing processes. As illustrated in FIG. 2, the resolution changing device 300 is connected to a TV 100 and a server 200 and includes an acquiring unit 301, a changing unit 302, and an output unit 303.

The resolution changing device 300 corresponds to, for example, a personal computer, a work station, or a home video game console. As described below, the resolution changing device 300 transmits a computer display to the TV 100. The computer display corresponds to a display of the computer in which important information, such as icons necessary for the user to operate the computer, on the edge of the display and video image content that is output by the computer.

FIG. 2 is a block diagram of the resolution changing device 300 that does not include a screen, but the resolution changing device 300 may include a screen.

Hereinafter, configurations of the TV and the server 200 will be described and then the acquiring unit 301, the changing unit 302, and the output unit 303 of the resolution changing device 300 will be described.

The TV 100 is connected to the acquiring unit 301 and the output unit 303. The TV 100 includes a TV storage unit 101 and a screen that displays video images. The TV 100 receives a computer display from the output unit 303 of the resolution changing device 300 and then displays the received computer display on the screen. The TV 100 includes a screen and a connector that receives video images from an external device, such as a tuner that receives video images that are broadcast from a broadcast station, the resolution changing device 300, or a digital versatile disc (DVD) player. Hereinafter, the maximum display resolution that can be displayed on the screen is referred to as a display viewing angle. The TV 100 does not have to include a tuner that receives video images broadcast from a broadcast station. The TV is represented as an example. Thus, the display device is not limited to TVs. Any type of display device can be used as long as the display device has a function of increasing input video image resolution by using a predetermined increase rate.

Display of a computer display by the TV 100 will be described more in detail using FIG. 3. FIG. 3 is a diagram illustrating the TV of the first embodiment. As illustrated in (1) of FIG. 3, upon receiving a computer display, the TV 100 increases the resolution (number of horizontal pixels×number of vertical pixels) of the computer display by using a predetermined increase rate. The TV 100 then displays an area of the resolution-increased computer display, which is an area meeting the display viewing angle. In the example of FIG. 3, the TV 100 displays only an area of the computer display that meets the display viewing angle “1280×720p”. The process of enlarging the received video image that the TV 100 receives by using a predetermined rate can be referred to as “overscan (when the predetermined increase rate is equal to or more than 1)” or “underscan (when the predetermined increase rate is less than 1)”.

The display viewing angle will be briefly described below. The display viewing angle represents the maximum resolution that can be displayed on the screen of the TV 100. For example, the display viewing angle corresponds to “1920×1080p (number of horizontal pixels 1920×number of vertical pixels 1080 progressive scanning)”, “1920×1080i (number of horizontal pixels 1920×number of vertical pixels 1080 interlace scanning)”, or “1280×720p (number of horizontal pixels 1280×number of vertical pixels 720 progressive scanning)”. The display viewing angle does not always match the display resolution of the screen of the TV 100. For example, even when the display resolution of the screen is “1366×768”, the display viewing angle may be “1920×1080p”.

The TV storage unit 101 stores information on the TV 100 and, for example, stores identification information for identifying the TV 100. For example, the TV storage unit 101 stores the “model name” of the TV 100. The information on the TV 100 that the TV storage unit 101 stores is also referred to as EDID (extended display identification data). For example, the “model name” that the TV 100 stores is read by the acquiring unit 301 using serial communications that are referred to as DDC (display data channel) when the TV 100 is connected to the resolution changing device 300 via a connection cable.

The information that is stored in the TV storage unit 101 is previously input by the manufacturer that manufactures the TV 100.

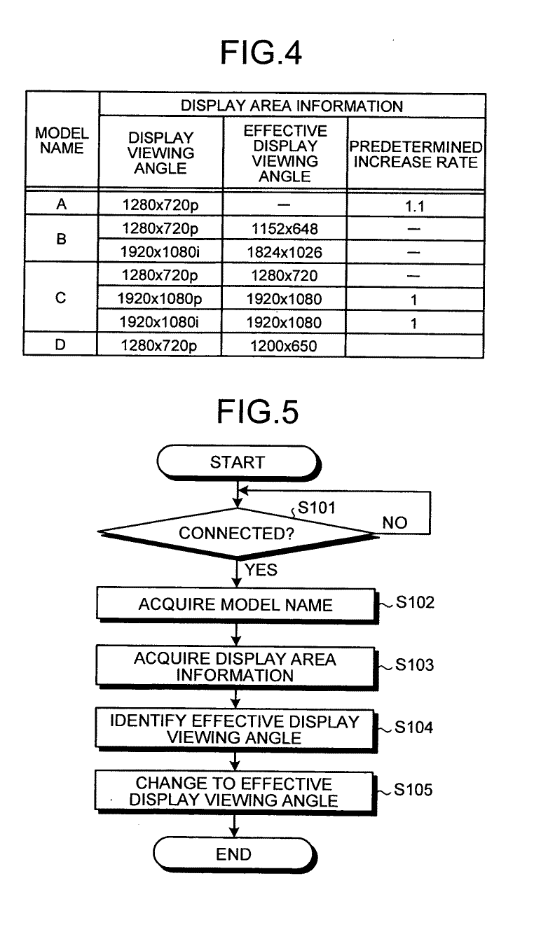

The server 200 is connected to the resolution changing device 300 via the Internet or an intranet. The server 200 includes a display area information storage unit 210. As illustrated in FIG. 4, the display area information storage unit 210 stores display area information in association with identification information that identifies a TV. In the example of FIG. 4, the display area information storage unit 210 stores the model name of the TV as identification information and stores, as display area information, a combination of an effective display viewing angle or a predetermined increase rate and a display viewing angle. The predetermined increase rate can be also referred to as an overscan rate or an underscan rate. FIG. 4 is a table of the display area information storage unit of the first embodiment.

In the example of FIG. 4, the display area information storage unit 210 stores a display viewing angle “1280×720p” and a predetermined increase rate “1.1” in association with a model name “A”. The display area information storage unit 210 also stores a combination of a display viewing angle “1280×720p” and an effective display viewing angle “1152×648” and a combination of a display viewing angle “1920×1080i” and an effective display viewing angle “1824×1026” in association with a model name “B”.

The storage of the two angles-of-view “1280×720p” and “1920×1080i” in association with the model name “B” represents that the TV “B” can selectively use those two display viewing angles. For example, the TV “B” displays video images on the screen by using the display viewing angle that is set by the user.

The display area information storage unit 210 may store a combination of a display viewing angle and any one of or both of an effective display viewing angle and a predetermined increase rate.

The information that the display area information storage unit 210 stores is, for example, previously input by a manager and is read by the acquiring unit 301 of the resolution changing device 300.

The configuration of each unit of the resolution changing device 300 will be described. The acquiring unit 301 is connected to the TV 100, the display area information storage unit 210, and the changing unit 302. The acquiring unit 301 acquires display area information on the TV 100 to which the resolution changing device 300 transmits a computer display. For example, upon receiving the model name that identifies the TV 100, on which the computer display is to be displayed, the acquiring unit 301 refers to the display area information storage unit 210 and acquires the display area information corresponding to the acquired model type.

An example of a method of acquiring display area information by using a model name that is acquired from a TV will be described. For example, the acquiring unit 301 reads EDID from the TV 100 by using the DDC when the acquiring unit 301 is connected to the TV 100 via the connection cable, when the resolution changing device 300 is started, or when power is supplied to the TV 100 to which the resolution changing device 300 is connected via the connection cable. The acquiring unit 301 acquires the model name that is contained in the read EDID and acquires a model name, such as “A” or “D”. In addition, upon acquiring the model name, the acquiring unit 301 acquires, from the display area information storage unit 210, display area information that is associated with the acquired model name. For example, if the acquiring unit 301 acquires the model name “A”, it acquires the display viewing angle “1280×720p” and the predetermined increase rate “1.1”. If the acquiring unit 301 acquires the model name “D”, it acquires the display viewing angle “1280×720p” and the effective display angle “1200×650”.

The acquiring unit 301 identifies the effective display viewing angle according to the acquired display area information and transmits the effective display viewing angle to the changing unit 302. For example, if the acquiring unit 301 acquires the effective display viewing angle “1200×650” as display area information, the acquiring unit 301 identifies that the effective display viewing angle is “1200×650” and transmits the effective display viewing angle “1200×650” to the changing unit 302.

For example, if the acquired display area information does not include any effective display viewing angle, the acquiring unit 301 identifies the effective display viewing angle by using the acquired display area information. Here, the case where the display viewing angle “1280×720p” and a predetermined increase rate “1.1” are acquired will be used as an example to further describe the method of identifying an effective display viewing angle. Because it is satisfactory if the video image resolution of the video image that is increased by using the predetermined increase rate be “1280×720p”, the acquiring unit 301 calculates “1163×654” by dividing the display viewing angle “1280×720p” by the predetermined increase rate “1.1”. The acquiring unit 301 identifies that the calculated “1163×654” is the effective display viewing angle and transmits the effective display viewing angle “1163×654” to the changing unit 302.

A case will be described where display area information on the TV 100 that selectively uses multiple display viewing angles is acquired. For example, when a user of the resolution changing device 300 specifies any one of the display viewing angles, the acquiring unit 301 acquires the display area information about the specified display viewing angle.

The changing unit 302 is connected to the acquiring unit 301 and the output unit 303. The changing unit 302 changes the resolution of the whole computer display to be displayed on the screen to the effective resolution that is identified according to the display area information that is acquired by the acquiring unit 301.

For example, the changing unit 302 includes a register that stores an effective display viewing angle. Upon receiving the effective display viewing angle “1163×654” from the acquiring unit 301, the changing unit 302 inputs the received effective display viewing angle “1163×654” into the register. The changing unit 302 then changes, to “1163×654”, the resolution of the computer display to be transmitted to the TV 100. The changing unit 302 transmits the resolution-changed computer display to the output unit 303.

The output unit 303 is connected to the changing unit 302 and the TV 100. The output unit 303 outputs, to the TV 100, the video image whose resolution is changed by the changing unit 302. For example, the output unit 303 receives, from the changing unit 302, the whole computer display whose resolution is changed to “1163×654” and outputs the computer display to the TV 100.

The video images that are output from the output unit 303 to the TV 100 are displayed on the screen of the TV 100. For example, the TV 100 enlarges the computer display of the display resolution “1163×654” to “1280×720p” and then displays the enlarged computer display on the screen of the display viewing angle “1280×720p”.

Process Performed by Resolution Changing Device

The flow of a process performed by the resolution changing device of the first embodiment will be described below using FIG. 5. FIG. 5 is a flowchart illustrating the flow of the process performed by the resolution changing device of the first embodiment.

As illustrated in FIG. 5, when the acquiring unit 301 is connected to the TV 100 (YES at step S101), the acquiring unit 301 acquires the model name of the TV 100 (step S102) and acquires the display area information that is associated with the acquired model name (step S103). In other words, the acquiring unit 301 acquires the display area information on the TV 100 to which the resolution changing device 300 will transmit the computer display.

The acquiring unit 301 identifies the effective display viewing angle (step S104). For example, when the acquiring unit 301 acquires the effective display viewing angle “1200×650” as the display area information, the acquiring unit 301 identifies that the effective display viewing angle is “1200×650” and transmits the effective display viewing angle “1200×650”. When the acquiring unit 301 acquires the display viewing angle “1280×720p” and the predetermined increase rate “1.1”, the acquiring unit 301 identifies the effective display viewing angle “1163×654” according to the acquired display viewing angle “1280×720p” and predetermined increase rate “1.1” and then transmits the effective display viewing angle “1163×654” to the changing unit 302.

The changing unit 302 changes the resolution of the whole computer display that will be displayed on the screen, to the effective display viewing angle that is identified according to the display area information, which is acquired by the acquiring unit 301 (step S105). For example, when the changing unit 302 receives the effective display viewing angle “1163×654” from the acquiring unit 301, the changing unit 302 changes the display resolution of the whole computer display to be transmitted to the TV 100 to the received effective display viewing angle “1163×654”.

Thereafter, the output unit 303 outputs the computer display whose resolution is changed by the changing unit 302 to the TV 100 and the TV 100 enlarges the received computer display by using the predetermined increase rate and then displays the enlarged computer display on the screen.

### Effects of the First Embodiment

As described above, in the first embodiment, the resolution changing device 300 acquires the display area information on the TV 100 and changes the resolution of the whole computer display to be displayed on the screen to the effective resolution that is identified according to the acquired display area information. Accordingly, the resolution changing device 300 can always perform a full display.

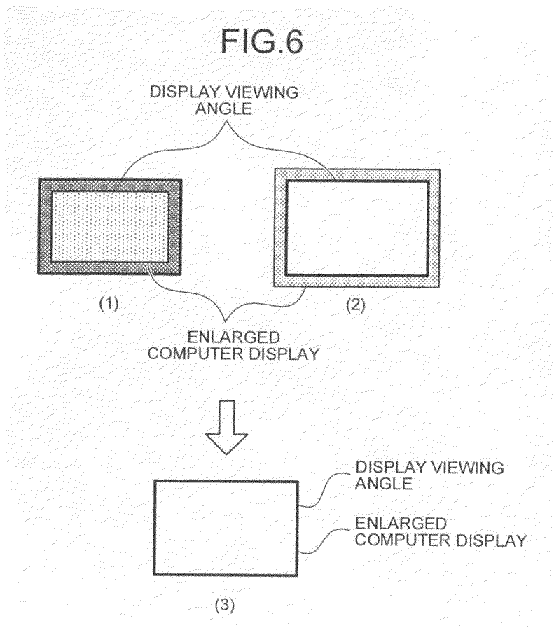

For example, as illustrated in FIG. 6, in the conventional method, the resolution of the computer display may be pre-reduced too much so that the resolution of the computer display enlarged by the TV 100 may be smaller than the display viewing angle (see (1) of FIG. 6). In addition, in the conventional method, the resolution of the computer display enlarged by the TV 100 may be larger than the display viewing angle and thus a part of the computer display may not be displayed (see (2) of FIG. 6). FIG. 6 is a diagram illustrating effects of the resolution changing device of the first embodiment.

In contrast to the conventional method, in the first embodiment, the resolution changing device 300 changes the resolution of the computer display to the effective resolution of the TV 100 and thus the resolution of the computer display increased by the TV 100 can be matched with the display viewing angle (see (3) of FIG. 6). In this manner, the resolution changing device 300 can change the resolution of a computer display to the resolution that can be displayed according to the whole screen of the TV 100.

### [b] Second Embodiment

The method in which the resolution changing device 300 acquires the display area information from the server 200 is described above as the first embodiment, but the present invention is not limited to this. Display area information may be acquired from the TV 100.

Hereinafter, a method of acquiring display area information from the TV 100 will be described as a second embodiment of the present invention. Hereinafter, aspects that are the same as those of the resolution changing device according to the first embodiment will be omitted from the description below.

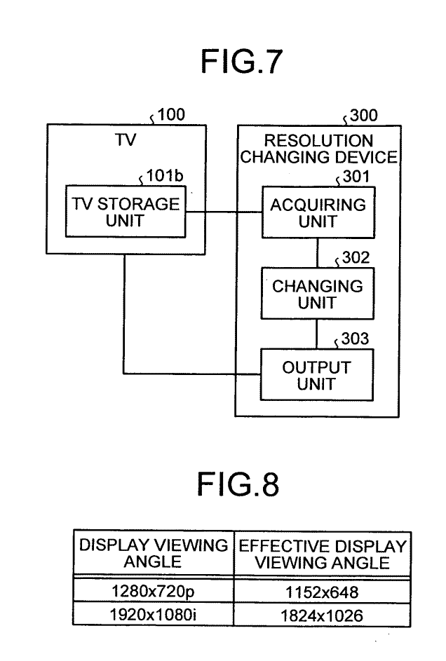

As illustrated in FIG. 7, the resolution changing device 300 according to the second embodiment is only connected to the TV 100, not to the server 200. FIG. 7 is a block diagram illustrating a configuration of the resolution changing device of the second embodiment.

As illustrated in FIG. 8, a TV storage unit 101b stores the display area information on the TV 100 as information on the TV 100. In the example of FIG. 8, the TV storage unit 101b stores display viewing angles and effective display viewing angles. For example, the TV storage unit 101b stores an association of a display viewing angle “1280×720p” and an effective display viewing angle “1152×648” and stores an association of a display viewing angle “1920×1080i” and an effective display viewing angle “1824×1026”. For example, the information that is stored in the TV storage unit 101b is previously input by the manufacturer that manufactured the TV 100. FIG. 8 is a table for describing the TV storage unit of the second embodiment.

In the resolution changing device 300 of the second embodiment, the acquiring unit 301 acquires the display area information from the TV 100 and reads EDID, for example, by using a DDC. The acquiring unit 301 acquires display area information that is contained in the read EDID and then acquires an effective display viewing angle.

### Effects of Second Embodiment

As described above, in the second embodiment, the resolution changing device 300 can acquire the display area information and can always perform a full screen display without the additional provision of the server 200 being necessary.

### [c] Third Embodiment

The embodiments of the present invention are described above. The present invention can be carried out by various different methods in addition to the methods of the above-described embodiments; therefore, other embodiments will be described below.

Display Area Information Storage Unit

In the first embodiment, the case is described where the information that the display area information storage unit 210 stores is previously input by the manager, but the present invention is not limited to this. For example, upon acquiring EDID by using a DDC and then acquiring the model name an the display area information according to the acquired EDID, the resolution changing device 300 may automatically input the acquired model name and the display area information into the display area information storage unit 210.

In addition, for example, in the first embodiment, the method in which the server 200 includes the display area information storage unit 210 is described, but the present invention is not limited to this. For example, the resolution changing device 300 may include the display area information storage unit 210.

Display Area Information Acquisition Timing

In the first embodiment, the method is described where the resolution changing device 300 acquires display area information from the display area information storage unit 210 every time upon acquiring a model name, but the present invention is not limited to this. For example, the resolution changing device 300 may include a storage unit. In this case, the resolution changing device 300 is previously connected to the server 200 and reads an association of a model name and display area information from the display area information storage unit 210 and inputs the read model name and the display area information into the storage unit.

Device from which Display Area Information is Acquired

For example, the method of acquiring the display area information from the server 200 is described in the first embodiment and the method of acquiring the display area information from the TV 100 is described in the second embodiment, but the present invention is not limited to these. Specifically, the method of acquiring the display area information from the server 200 and the method of acquiring the display area information from the TV 100 may be carried out together.

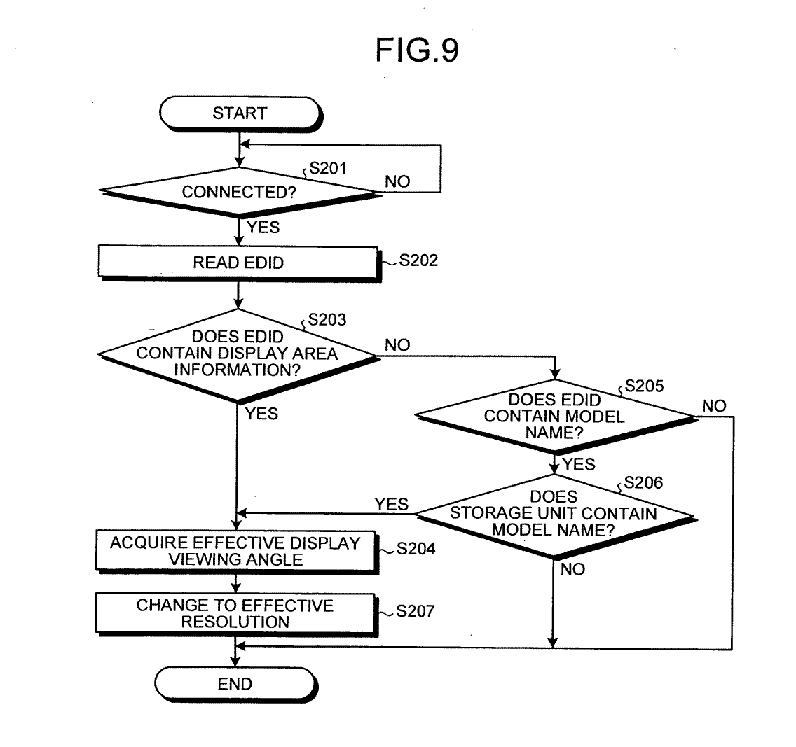

For example, an example will be described of the flow of a process performed by the resolution changing device 300 for acquiring display area information from the server 200 or the TV 100. FIG. 9 is a flowchart of an example of the flow of a process of the resolution changing device that acquires the resolution from the server or the TV.

As illustrated in FIG. 9, in the resolution changing device 300, when the acquiring unit 301 is connected to the TV 100 (YES at step S201), the acquiring unit 301 reads EDID on the TV (step S202). The acquiring unit 301 then determines whether the read EDID contains display area information (step S203). Here, when the acquiring unit 301 determines that the RDID contains display area information (YES at step S203), the acquiring unit 301 acquires the display area information and then acquires an effective display angle (step S204).

In contrast, when the acquiring unit 301 determines that the EDID does not contain any display area information (NO at step S203), the acquiring unit 301 determines whether the read EDID contains a model name (step S205). When the acquiring unit determines that the EDID contains a model name (YES at step S205), the acquiring unit 301 determines whether the contained model name is stored in the display area information storage unit 210 (step S206). When the acquiring unit 301 determines that the display area information storage unit 210 contains that model name (YES at step S206), the acquiring unit 301 acquires the display area information associated with the acquired model name and then acquires the effective display viewing angle (step S204).

The changing unit 302 changes the resolution of the video image to the acquired effective resolution (step S207).

In contrast, when the acquiring unit 301 determines that the read EDID does not contain any model name (NO at step S205) or determines that the display area information storage unit 210 does not contain any model name (NO at step S206), the acquiring unit 301 ends the process.

As described above, only when the EDID on the TV does not contain any display area information, by acquiring the display area information from the display area information storage unit 210, the volume of processing can be reduced and, accordingly, fast processing can be performed.

System Configuration

Among the above-described processes performed by the embodiments, the processes described as being automatically performed may be manually performed entirely or partially. For example, the user may input a model name manually in the resolution changing device 300. Furthermore, the process procedures, control procedures, and specific names, which are illustrated in the specification and the drawings, and information including various types of data and parameters (for example, FIG. 1 to FIG. 9) may be changed arbitrarily unless otherwise noted.

The elements of each device illustrated in the drawings are functional ideas and do not need to be physically configured as illustrated in the drawings. In other words, the specific modes of separation or integration of each device are not limited to those illustrated in the drawings and the devices may be configured in a way that they are entirely or partially separated or integrated functionally or physically on an arbitrary basis in accordance with various loads or how they are used.

Such separation and integration will be described using the block diagram of FIG. 2. The TV 100, the server 200, and the resolution changing device 300 may be integrated partially or entirely. Alternatively, the server 200 may perform a part of the processes performed by the resolution changing device 300.

Computer

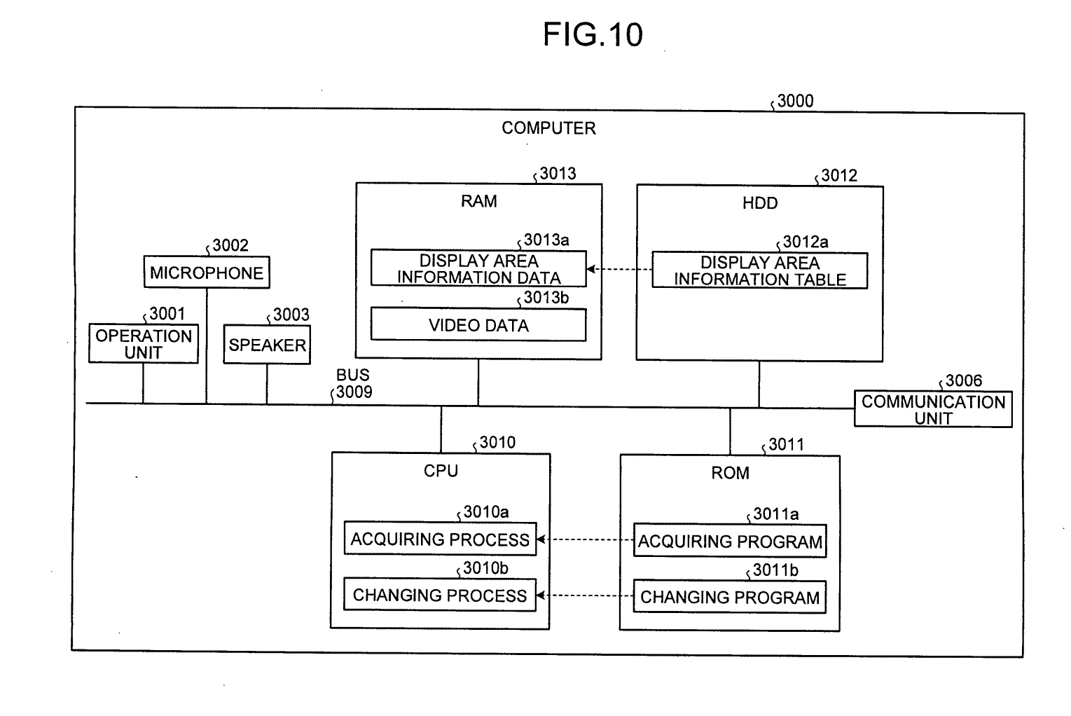

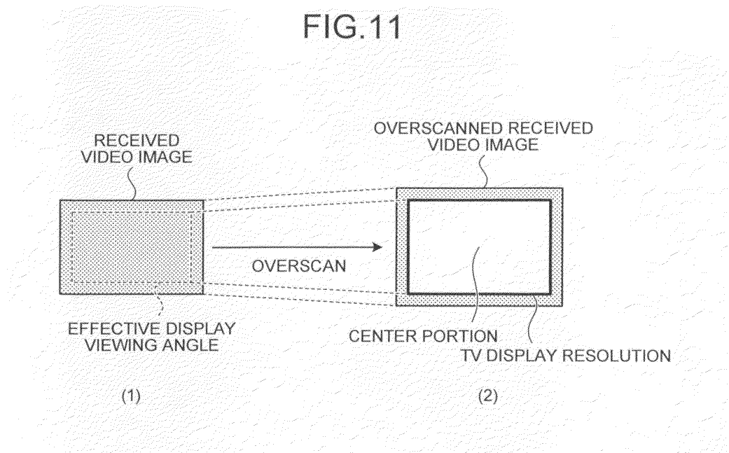

Various types of processes that are described in the above-described embodiments can be achieved by executing a prepared program using a computer, such as a personal computer or a work station. An example of a computer that executes a resolution changing program that achieves the same functions as those of the above-described embodiments will be described using FIG. 10. FIG. 10 is a diagram describing the program of the resolution changing device of the first embodiment.

As illustrated in FIG. 10, a computer 3000 of the first embodiment includes an operation unit 3001, a microphone 3002, a speaker 3003, a communication unit 3006, a CPU 3010, a ROM 3011, a HDD 3012, and a RAM 3013 that are connected via a bus 3009.

The ROM 3011 previously stores a control program for achieving the same functions as those of the acquiring unit 301 and the changing unit 302 of the first embodiment, i.e., stores, as illustrated in FIG. 10, an acquiring program 3011a and a changing program 3011b. The programs 3011a and 3011b may be appropriately integrated or separated, as are the elements of the resolution changing device in FIG. 2.

The CPU 3010 reads the programs 3011a and 3011b from the ROM 3011 and executes the programs 3011a and 3011b. Accordingly, as illustrated in FIG. 10, the programs 3011a and 3011b serve as an acquiring process 3010a and a changing process 3010b. The processes 3010a and 3010b correspond respectively to the acquiring unit 301 and the changing unit 302 in FIG. 2.

The HDD 3012 is provided with a display area information table 3012a. The display area information table 3012a corresponds to the display area information storage unit 210 in FIG. 2.

The CPU 3010 reads the display area information table 3012a, stores the display area information table 3012a in the RAM 3013, and executes the resolution changing program by using display area information data 3013a and video data 3013b that are stored in the RAM 3013. The video data corresponds to, for example, the data about the computer display.

Other Aspects

The resolution changing program described in the embodiments may be distributed via a network, such as the Internet. The resolution changing program may be executed in a way that the program is stored in a computer-readable recording medium, such as a hard disk, a flexible disk (FD), a CD-ROM, an MO, or a DVD, and is read by the computer from the recording medium.

According to an embodiment disclosed by the present application, full display can be performed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A resolution changing device comprising:
an acquiring unit that acquires resolution information on a display device that enlarges a received video image by using a predetermined enlargement rate and displays, on a screen, an area of the enlarged video image, which is an area meeting a predetermined display resolution, the resolution information identifying an effective resolution that is a video image resolution that indicates the area of the video image before the enlargement, which is an area to be displayed on the screen; and
a changing unit that changes a resolution of the whole of a computer display to be displayed on the screen to the effective resolution that is identified according to the resolution information acquired by the acquiring unit.

2. The resolution changing device according to claim 1, wherein, upon receiving identification information that identifies the display device on which the computer display is to be displayed, the acquiring unit refers to a storage unit that stores the resolution information in association with the identification information that identifies the display device and the acquiring unit then acquires the resolution information corresponding to the acquired identification information.

3. The resolution changing device according to claim 2, wherein the display device includes a storage unit that stores resolution information on the display device, and
the acquiring unit acquires the resolution information, which is stored in the storage unit, from the display device.

4. The resolution changing device according to claim 3, wherein the resolution information is a combination of the display resolution of the screen and an effective resolution and/or the predetermined enlargement rate.

5. The resolution changing device according to claim 1, wherein the display device is a television.

6. A resolution changing method comprising:
acquiring resolution information on a display device that enlarges a received video image by using a predetermined enlargement rate and displays, on a screen, an area of the enlarged video image, which is an area meeting a predetermined display resolution, the resolution information identifying an effective resolution that is a video image resolution that indicates the area of the video image before the enlargement, which is an area to be displayed on the screen; and
changing a resolution of the whole of a computer display to be displayed on the screen to the effective resolution that is identified according to the resolution information acquired by the acquiring unit.

7. A non-transitory computer readable storage medium storing therein a resolution changing program causing a computer to perform:
acquiring resolution information on a display device that enlarges a received video image by using a predetermined enlargement rate and displays, on a screen, an area of the enlarged video image, which is an area meeting a predetermined display resolution, the resolution information identifying an effective resolution that is a video image resolution that indicates the area of the video image before the enlargement, which is an area to be displayed on the screen; and
changing a resolution of the whole of a computer display to be displayed on the screen to the effective resolution that is identified according to the resolution information acquired by the acquiring unit.
